(19) United States
(12) Patent Application Publication
(10) Pub. No.: US 2025/0236246 A1
(43) Pub. Date: Jul. 24, 2025

(54) MODULAR DUAL-BOARD ELECTRONIC CONTROL UNIT

(71) Applicants: Gert Edzko SMID, Oxford, MI (US); Gerd SCHLAGER, Kefermarket (AT); Michael NEUDORFHOFER, Sankt Valentin (AT); MAGNA INTERNATIONAL INC., Aurora (CA)

(72) Inventors: Gert Edzko SMID, Oxford, MI (US); Gerd SCHLAGER, Kefermarkt (AT); Michael NEUDORFHOFER, Sankt Valentin (AT)

(21) Appl. No.: 18/703,516

(22) PCT Filed: Oct. 21, 2022
(86) PCT No.: PCT/US2022/047370

§ 371 Date: Apr. 22, 2024

Related U.S. Application Data
(60) Provisional application No. 63/270,674, filed on Oct. 22, 2021.

(51) Int. Cl. B60R 16/023

(52) U.S. Cl. CPC B60R 16/0238

(57) ABSTRACT

A modular electronic control unit for a vehicle includes an enclosure, a power control board disposed within the enclosure and including one or more power electronic devices, and a compute board disposed within the enclosure, separate from the power control board and including one or more high-performance processor devices configured to perform one or more application software functions. A domain control system for a vehicle includes a modular electronic control unit. The modular electronic control unit including an enclosure and a compute board disposed within the enclosure and including one or more high-performance processor devices configured to perform one or more application software functions. The domain control system also includes one or more remote power interfaces located remotely from the modular electronic control unit and in functional communication therewith via a controller network interconnection.

### CROSS-REFERENCE TO RELATED APPLICATION

This PCT International Patent application claims the benefit of and priority to U.S. Provisional Patent Application Ser. No. 63/270,674 filed on Oct. 22, 2021 titled “Modular Dual-Board Electronic Control Unit,” the entire disclosure of which is hereby incorporated by reference.

### FIELD

The present disclosure relates generally to electronic control units (ECUs) for onboard systems in vehicles.

### BACKGROUND

Many conventional electronic control units (ECUs) for onboard systems in vehicles include the following components: complex, low voltage, low current computing components, such as processors, controllers, System-on-Chip (SoC), etc.; and high voltage, high current power electronic devices, such as amplifier and driver components (H-bridges, MOSFETs, relays, etc.).

Vehicle control systems may include Domain Controllers and Edge controllers that have combined compute and power control devices, which may be distributed to be in the vicinity of sensors and/or actuators. Cabling and Harnesses may not be optimized, and software for computing functions may be distributed across a multitude of processors.

### SUMMARY

The present disclosure provides a modular electronic control unit for a vehicle. The modular electronic control unit comprises an enclosure; a power control board disposed within the enclosure and including one or more power electronic devices; and a compute board disposed within the enclosure, separate from the power control board and including one or more high-performance processor devices configured to perform one or more application software functions.

The present disclosure also provides a domain control system for a vehicle. The domain control system comprises a modular electronic control unit including an enclosure and a compute board disposed within the enclosure and including one or more high-performance processor devices configured to perform one or more application software functions. The domain control system also comprises one or more remote power interfaces located remotely from the modular electronic control unit and in functional communication therewith via a controller network interconnection.

### BRIEF DESCRIPTION OF THE DRAWINGS

Further details, features and advantages of designs of the invention result from the following description of embodiment examples in reference to the associated drawings, in which a battery frame is disclosed.

FIG. 1 shows a schematic diagram of a vehicle including a domain control system with a body ECU having an integrated power control circuit board, and with additional power control circuit boards located remotely from the body ECU.

FIG. 2 shows a schematic diagram of a modular ECU in accordance with an aspect of the disclosure.

FIG. 3 shows a cross-sectional side view of a modular ECU, in accordance with an aspect of the disclosure.

FIG. 4 shows a top view showing two circuit boards of the modular ECU of FIG. 2, in accordance with an aspect of the disclosure.

FIG. 5 shows a schematic diagram of a first system including a network interface between separate circuit boards, in accordance with an aspect of the disclosure.

FIG. 6 shows a schematic diagram of a second system including a network interface between a compute circuit board and two or more power control circuit boards.

### DETAILED DESCRIPTION

Recurring features are marked with identical reference numerals in the figures, in which example embodiments of a modular electronic control unit (ECU) and a domain control system that includes the modular control ECU are disclosed.

According to an aspect of the present disclosure, a modular ECU includes a compute board and a power control board. Either or both of the power control board and/or the compute board can be replaced separately to create variants of the modular ECU. The modular ECU of the present disclosure may simplify the assembly process and reduce costs, since no interfaces, connectors or other mounting elements may be needed between the compute board and the power control board.

According to an aspect of the present disclosure, a centralized compute board with one or more decentralized or remote power interfaces is provided. The modular ECU of the present disclosure, and systems including such modular ECUs may provide a reduction in cost of computing resources, a reduction in cost of wiring/connectors/harnessing. Furthermore, the modular ECU of the present disclosure may provide for increased consolidation of software components, reducing costs for development and maintenance of software.

The modular ECU of the present disclosure may be used to create different ECU variants having different power control boards. Each of the different power control boards may have a different configuration of power control devices for controlling power supply to external devices. In some embodiments, the different ECU variants may each have a compute board with a similar or identical construction.

The power control board may include a second PCB having 2-4 conductive layers, with each of the layers being relatively thick when compared with the layers of the first PCB. The relatively thick conductors of the second PCB may enable higher current flow than is possible in the conductors of the relatively thin layers of the first PCB. The power control board may be less expensive than the compute board.

In some embodiments, one or more of power control boards may be located relatively close to external devices connected thereto, such as sensors and/or actuators. This may minimize the amount of wiring and wiring harnesses required, providing reduced overall system costs.

In some embodiments, a domain control system that includes the modular ECU 20 of the present disclosure may include fewer processors than conventional control systems, which may provide cost savings in materials and also in software development, deployment, and maintenance. By splitting the compute board and the power control circuits on the power control board, software functions for many traditional functions can be consolidated in a single compute board. This simplifies software maintenance. The power control boards can be installed as close as possible to the sensors and actuators, minimizing harnessing. At the same time, the option to install a compute board and a power control board in a single ECU enclosure offers opportunity to simplify installation and reduce connectors and wiring.

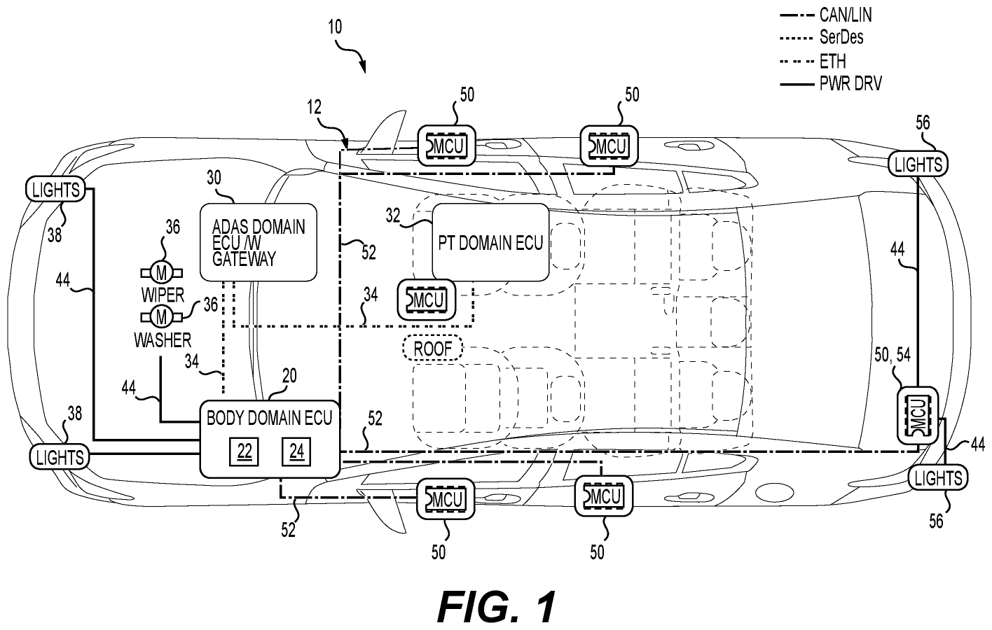

FIG. 1 shows a schematic diagram of a vehicle 10 including a domain control system 12 with a modular ECU 20 having a power control board 22, and with remote power interfaces 50 located remotely from the modular ECU 20. In some embodiments, and as shown in FIG. 1, the modular ECU 20 may be used as a body ECU for controlling various devices and functions associated with the body of the vehicle. The body ECU may be distinguished from other ECUs in the vehicle, such as a powertrain control module (PCM) that is primarily used for controlling powertrain devices, such as engine actuators and sensors. The power control board 22 may also be called an amplifier board. The power control board 22 and the remote power interfaces 50 may each provide relatively high electrical current for operating various electrical loads, such as lights, motors, and other actuators. The modular ECU 20 also includes a compute board 24, which includes one or more high-performance processor devices configured to perform one or more application software functions. The application software functions may include, for example, processing signals from one or more sensors, and/or generating commands for operating one or more actuators. The application software functions may include complex computations, such as image processing, complex algorithms for motor current control, etc. The application software functions may include communications functions for communicating with other systems within the vehicle and/or for controlling input and output devices for communicating with a user.

The domain control system 12 includes an advanced driver-assistance system (ADAS) ECU 30 and a powertrain (PT) domain ECU 32 each in communication with the modular ECU 20 via Ethernet network interconnections 34. The Ethernet network interconnections 34 may provide high-speed and high-bandwidth communications between the ECUs 20, 30, 32 of the domain control system 12 within the vehicle 10.

The vehicle 10 also includes several motors 36, which may be used, for example, to actuate windshield wipers, and/or to pump washer fluid for cleaning the windshield of the vehicle 10. The vehicle 10 also includes front lights 38, which may include headlights, marker lights, turn signals, etc. The motors 36 and the front lights 38 are each connected to the modular ECU 20 via a power interconnection 44. Each of the power interconnections 44 may include that includes one or more cables and/or connectors. The modular ECU 20 supplies the electrical power to operate each of the motors 36 and the front lights 38 in the domain control system 12 of FIG. 1.

The domain control system 12 of FIG. 1 also includes several remote power interfaces 50, with each of the remote power interfaces 50 in communication with the modular ECU 20 via controller network interconnections 52. The controller network interconnections 52 may include Controller Area Network (CAN) and/or Local Interconnect Network (LIN) network interconnections, although other types of digital communications interfaces may be used.

The domain control system 12 of FIG. 1 also includes one of the remote power interfaces 50 that is configured as a rear light interface 54. The vehicle 10 also includes two tail lights 56, which may include brake lights, turn signals, reverse indicating lights, etc. The tail lights 56 are each connected to the rear light interface 54 via a power interconnection 44, and the rear light interface 54 supplies the electrical power to operate each of the tail lights 56 in the domain control system 12 of FIG. 1.

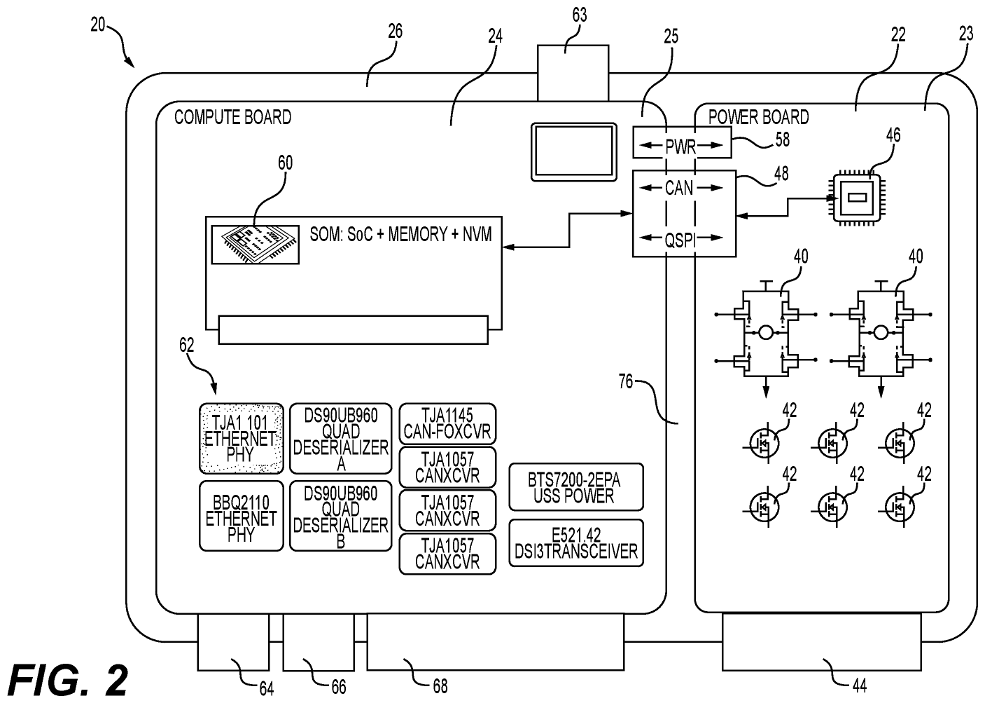

FIG. 2 shows a schematic diagram of the modular ECU 20. The modular ECU 20 includes a power control board 22 and a compute board 24, each located within an enclosure 26. The power control board 22 includes a first printed circuit board (PCB) 23, and the compute board 24 includes a second PCB 25. The first PCB 23 may include between two and four conductive layers of electrically conductive material, such as copper, spaced apart from one another by insulating material. Each of the conductive layers in the first PCB 23 may be relatively thick to provide current carrying capacity required for operating the power control board 22. The second PCB 25 may include more than four conductive layers of conductive material, such as copper, spaced apart from one another by insulating material. For example, the second PCB 25 may include 12-14 conductive layers. Each of the conductive layers in the second PCB 25 may be relatively thin when compared to the conductive layers of the first PCB 23.

Still referring to FIG. 2, the power control board 22 includes several power electronic devices 40, 42 including H-bridges 40 configured to supply DC power to an external device, such as a motor, in either of two opposite polarities. The power electronic devices 40, 42 also include several field effect transistors 42 which may be used for various power supply functions, such as in an amplifier, a power inverter, or in an inverter for generating AC power. A power interconnection 44 provides an electrical interface between the power electronic devices 40, 42 of the power control board 22 and remotely located devices, such as motors and lamps. The power interconnection 44 may include a receptacle for receiving a corresponding socket of a wiring harness.

The power control board 22 also includes an interface controller 46, which may be a very simple controller that is programmed or otherwise configured to control the operation of the power electronic devices 40, 42 in response to commands received via a data interconnection 48. The data interconnection 48 may include one or more Controller Area Network (CAN) and/or Quad Serial Peripheral Interface (QSPI) network interconnections, although other types of digital communications interfaces may be used. A power interconnection 58 may provide power from the power control board 22 to the compute board 24. In some embodiments, and as shown in the FIGs., the data interconnection 48 and the power interconnection 58 are the only functional interconnections between the power control board 22 and the compute board 24, and there are no other shared devices or interconnections. There may be no plug-in connectors between the power control board 22 and the compute board 24.

The compute board 24 includes a high-performance processor device 60 configured to perform one or more application software functions. The high-performance processor device 60 may include one or more microprocessors, microcontrollers, and/or System-on-Chip (SoC) components. The high-performance processor device 60 may include one or more memory components. For example, the high-performance processor device 60 may include 32 Gigabits (Gb) of static random access memory (SRAM), 16 Megabits (Mb) of NOR Flash memory, and 2 Gb of NAND Flash memory. One or more of the Flash memory devices may be configured as non-volatile memory (NVM) that may be written during initial factory setup, but which is configured not to be writable after installation in a vehicle. The high-performance processor device 60 may include, for example, a MT53D1024M32D4DT-046 device by Micron Technologies.

The high-performance processor device 60 may command the interface controller 46 via the data interconnection 48 for controlling the power electronic devices 40, 42. The compute board 24 includes also includes one or more interfaces 63, 64, 66, 68 for connection to external devices. The interfaces 63, 64, 66, 68 may include a first display interface 63, such as a Flat panel display link (FPD-Link) interface configured to transmit video data. The interfaces 63, 64, 66, 68 may include network interfaces 64, 66, such as an Ethernet connector 64, and/or a second display interface 66, such as an FPD-Link connector, configured to receive video data from an external source, such as from one or more cameras. Alternatively or additionally, the interfaces 64, 66, 68 may include a low-power wiring interface 68, such as a wiring receptacle for connecting to low-power devices that are external to the modular ECU 20. Such low-power external devices may include, for example, sensors, switches, indicator lights, etc. In some embodiments, the low-power wiring interface 68 may include one or more data connections such as CAN or LIN interfaces.

In some embodiments, the compute board 24 may include other computing components 62, such as one or more microprocessors or microcontrollers, and/or other integrated circuits, which may be called chips. The other integrated circuits may include, for example, memory chips, communication interface chips, etc. Because of the complex, multi-layer PCB and the integrated circuits and other devices attached thereto, the compute board may be relatively expensive. In some embodiments, the compute board 24 may account for a majority of the cost of the modular ECU 20. In some embodiments, the compute board 24 may perform multiple different computing functions or capabilities. Such different computing functions or capabilities may have be performed by different processors in different ECUs in conventional systems.

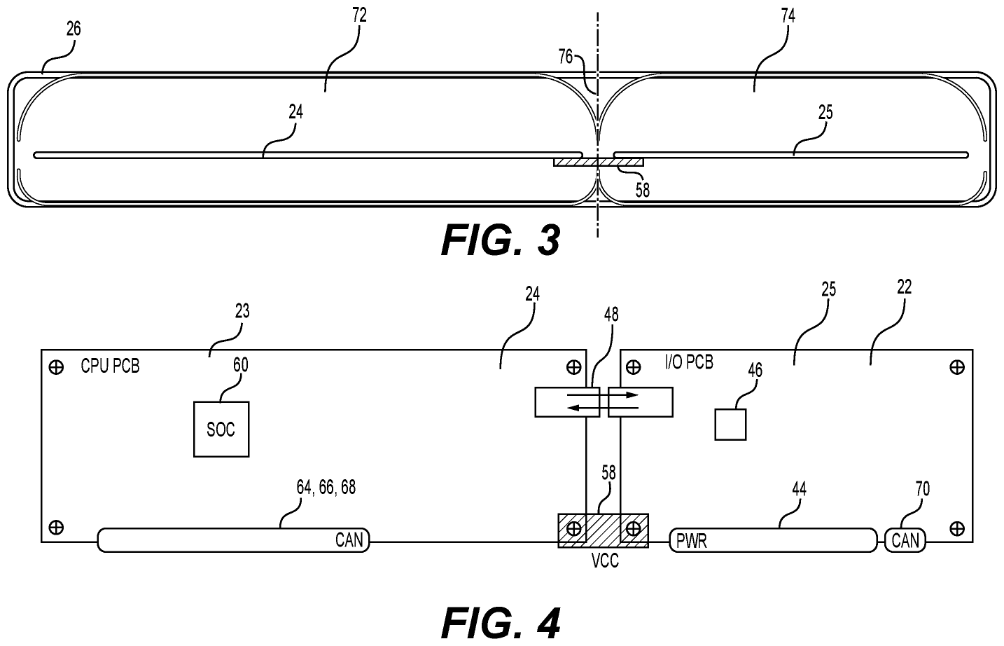

FIG. 3 shows a cross-sectional side view of the modular ECU 20. The compute board 24 receives power supply from the power control board 22 via the power interconnection 58 and one or more mounting fasteners, such as screws, bolts, or studs, which also function to secure the compute board 24 within the enclosure 26. The enclosure 26 may be connected to an electrical ground. In some embodiments, the enclosure 26 may be used to carry electrical current at the ground potential. In case the enclosure 26 is non-conductive (e.g., plastic), then a second mounting conductor (not shown) can be used to conduct current at the ground potential from the power control board 22 to the compute board 24. This may eliminate any need for separate connectors for power. The enclosure 26 includes two isolated chambers 72, 74 that contain the compute board 24 and the second PCB 25, respectively. The enclosure 26 includes a partition 76 that separates the two isolated chambers 72, 74. The data interconnection 48 and the power interconnection 58 may each pass through the partition 76 between the two isolated chambers 72, 74. In some embodiments, the partition 76 may be configured to prevent electromagnetic interference (EMI) from being transmitted between the two isolated chambers 72, 74.

The interface controller 46, which may include a small and simple processor on the power control board 22, supports the data interconnection 48 for communication between the compute board 24 and the power electronic devices 40, 42 of the power control board 22. The interface controller 46 does not contain any application software functions.

The data interconnection 48 between the compute board 24 and the power control board 22 inside the enclosure 26 may include an electrically-isolated bridge, which may prevent or reduce cross-coupling that could otherwise result from switching currents in the power control board 22. This bridge may include an opto-coupler and/or an inductive coupling. These bridging solutions may reduce cost over a CAN or Ethernet communication link, while isolating the electric interface.

FIG. 4 shows a top view showing two circuit boards 23, 25 of the modular ECU 20. In some embodiments, and as shown in FIG. 4, the power control board 22 includes an external network interface 70, such as a CAN interface, which may provide connection to an external data network. In some embodiments, the interface controller 46 may be configured to accept control commands from either or both of the data interconnection 48 and/or the external network interface 70 for controlling the power electronic devices 40, 42 of the power control board 22.

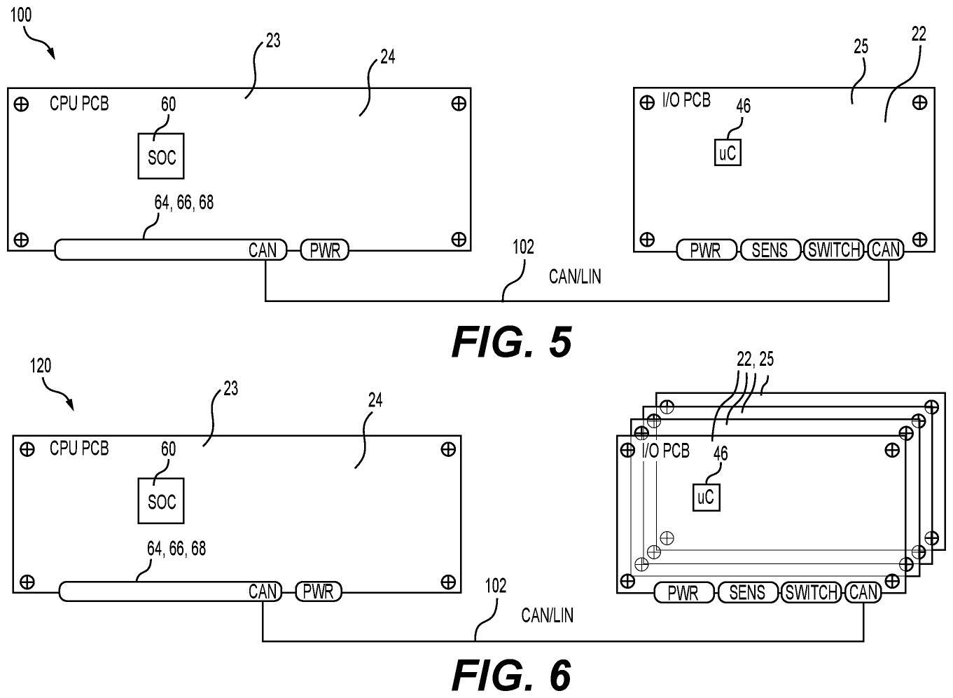

FIG. 5 shows a schematic diagram of a first system 100 including a network interconnection 102, such as a CAN or LIN network, between separate circuit boards 23, 25, which may physically separate from one another. The power control board 22 can be separated from the compute board 24, for example to be close to the sensors and actuators in a vehicle.

FIG. 6 shows a schematic diagram of a second system 120 including a network interconnection 102, such as a CAN or LIN network, between a compute board 24 and two or more power control circuit boards 25. In some embodiments, the compute board 24 can simultaneously control several different power control boards 22.

A modular electronic control unit for a vehicle includes an enclosure, and a power control board disposed within the enclosure and including one or more power electronic devices. The modular electronic control unit also includes a compute board disposed within the enclosure, separate from the power control board and including one or more high-performance processor devices configured to perform one or more application software functions.

In some embodiments, the modular electronic control unit is configured to support multiple different variants by swapping-out one of the power control board or the compute board with a different board having a different configuration.

In some embodiments, the one or more high-performance processor devices are configured to control operation of the one or more power electronic devices.

In some embodiments, the modular electronic control unit further includes a data interconnection between the compute board and the power control board and configured to transmit data therebetween while providing electrical isolation therebetween.

In some embodiments, the data interconnection includes at least one of an opto-coupler or an inductive coupling.

In some embodiments, the power control board includes a first printed circuit board (PCB) having between two and four conductive layers and the compute board includes a second PCB having more than four conductive layers.

In some embodiments, the modular electronic control unit further includes a mounting fastener configured to secure the compute board within the enclosure; and a power interconnection configured to transmit power from the power control board to the compute board via the mounting fastener.

A domain control system for a vehicle includes: a modular electronic control unit including an enclosure and a compute board disposed within the enclosure and including one or more high-performance processor devices configured to perform one or more application software functions; and one or more remote power interfaces located remotely from the modular electronic control unit and in functional communication therewith via a controller network interconnection.

In some embodiments, the one or more remote power interfaces includes two or more of the remote power interfaces.

In some embodiments, the one or more high-performance processor devices are further configured to control operation of the one or more remote power interfaces.

In some embodiments, the modular electronic control unit is configured to support multiple different variants by swapping-out the compute board with a different board having a different configuration.

In some embodiments, the modular electronic control unit further includes a power control board disposed within the enclosure, separate from the compute board and including one or more power electronic devices.

In some embodiments, the one or more high-performance processor devices are configured to control operation of the one or more power electronic devices.

In some embodiments, the one or more high-performance processor devices are electrically isolated from the one or more power electronic devices.

In some embodiments, the power control board includes a first printed circuit board (PCB) having between two and four conductive layers and the compute board includes a second PCB having more than four conductive layers.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A modular electronic control unit for a vehicle, comprising:
an enclosure;
a power control board disposed within the enclosure and including one or more power electronic devices; and
a compute board disposed within the enclosure, separate from the power control board and including one or more high-performance processor devices configured to perform one or more application software functions.

2. The modular electronic control unit of claim 1, wherein the modular electronic control unit is configured to support multiple different variants by swapping-out one of the power control board or the compute board with a different board having a different configuration.

3. The modular electronic control unit of claim 1, wherein the one or more high-performance processor devices are configured to control operation of the one or more power electronic devices.

4. The modular electronic control unit of claim 1, further comprising a data interconnection between the compute board and the power control board and configured to transmit data therebetween while providing electrical isolation therebetween.

5. The modular electronic control unit of claim 4, wherein the data interconnection includes at least one of an opto-coupler or an inductive coupling.

6. The modular electronic control unit of claim 1, wherein the power control board includes a first printed circuit board (PCB) having between two and four conductive layers and the compute board includes a second PCB having more than four conductive layers.

7. The modular electronic control unit of claim 1, further comprising a mounting fastener configured to secure the compute board within the enclosure; and
a power interconnection configured to transmit power from the power control board to the compute board via the mounting fastener.

8. A domain control system for a vehicle, comprising:
a modular electronic control unit including an enclosure and a compute board disposed within the enclosure and including one or more high-performance processor devices configured to perform one or more application software functions; and
one or more remote power interfaces located remotely from the modular electronic control unit and in functional communication therewith via a controller network interconnection.

9. The domain control system of claim 8, wherein the one or more remote power interfaces includes two or more of the remote power interfaces.

10. The domain control system of claim 8, wherein the one or more high-performance processor devices are further configured to control operation of the one or more remote power interfaces.

11. The domain control system of claim 8, wherein the modular electronic control unit is configured to support multiple different variants by swapping-out the compute board with a different board having a different configuration.

12. The domain control system of claim 8, wherein the modular electronic control unit further includes a power control board disposed within the enclosure, separate from the compute board and including one or more power electronic devices.

13. The domain control system of claim 12, wherein the one or more high-performance processor devices are configured to control operation of the one or more power electronic devices.

14. The domain control system of claim 12, wherein the one or more high-performance processor devices are electrically isolated from the one or more power electronic devices.

15. The domain control system of claim 12, wherein the power control board includes a first printed circuit board (PCB) having between two and four conductive layers and the compute board includes a second PCB having more than four conductive layers.

16. The modular electronic control unit of claim 1, wherein there are no plug-in connectors between the power control board and the compute board.

17. A domain control system for a vehicle, comprising:
a modular electronic control unit including:
an enclosure;
a power control board disposed within the enclosure and including one or more power electronic devices; and
a compute board disposed within the enclosure, separate from the power control board and including one or more high-performance processor devices configured to perform one or more application software functions.

18. The domain control system of claim 17, wherein the modular electronic control unit is configured to support multiple different variants by swapping-out one of the power control board or the compute board with a different board having a different configuration.

19. The domain control system of claim 17, wherein the one or more high-performance processor devices are configured to control operation of the one or more power electronic devices.

20. The domain control system of claim 17, wherein further comprising a data interconnection between the compute board and the power control board and configured to transmit data therebetween while providing electrical isolation therebetween.
